(19) United States
(12) Patent Application Publication
(10) Pub. No.: US 2008/0195705 A1
(43) Pub. Date: Aug. 14, 2008

(54) METHODS OF COLLABORATING WITHIN A SHARED ELECTRONIC CALENDAR

(75) Inventor: Yong Lee, Chandler, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/105,079

(22) Filed: Apr. 17, 2008

Related U.S. Application Data
(63) Continuation-in-part of application No. 12/050,443, filed on Mar. 18, 2008.
Application No. 12/050,443 is a continuation-in-part of application No. 12/050,468, filed on Mar. 18, 2008.
Application No. 12/050,468 is a continuation-in-part of application No. 12/050,477, filed on Mar. 18, 2008.

(51) Int. Cl. G06F 15/16; G06Q 10/00

(52) U.S. Cl. 709/204; 705/8

(57) ABSTRACT

Methods of the present invention provide for collaborating within a shared electronic calendar. An exemplary method may comprise the steps of scheduling an event in an electronic calendar, notifying a plurality of users of the event, and collaborating with the users regarding the event via a collaboration tool on the electronic calendar. The collaborating step may be accomplished by accessing a record (accessible to the plurality of users) of the event stored in the electronic calendar, viewing revisions (if any) to the record made by other users, and further revising the record for further review and comment by the other users.

### CROSS REFERENCE TO RELATED PATENT APPLICATIONS

This patent application is a continuation-in-part of the following previously-filed patent applications:

U.S. patent application Ser. No. 12/050,443 to Lee, et. al., with filing date Mar. 18, 2008 and titled: “AN ELECTRONIC CALENDARING SYSTEM WITH AN EXPOSED APPLICATION PROGRAMMING INTERFACE.”

U.S. patent application Ser. No. 12/050,468 to Lee, et. al., with filing date Mar. 18, 2008 and titled: “GRANTING ELECTRONIC CALENDAR ACCESS TO A SECOND PARTY VIA AN EXPOSED APPLICATION PROGRAMMING INTERFACE.”

U.S. patent application Ser. No. 12/050,477 to Lee, et. al., with filing date Mar. 18, 2008 and titled: “RECEIVING ELECTRONIC CALENDAR ACCESS FROM A FIRST PARTY VIA AN EXPOSED APPLICATION PROGRAMMING INTERFACE.”

This patent application is related the following concurrently-filed patent application, which also is assigned to The Go Daddy Group, Inc.:

U.S. patent application Ser. No. ______, “SYSTEMS FOR COLLABORATING WITHIN A SHARED ELECTRONIC CALENDAR.”

The subject matter of all patent applications is commonly owned and assigned to The Go Daddy Group, Inc. All prior applications are incorporated herein in their entirety by reference.

### FIELD OF THE INVENTION

The present inventions generally relate to the field of electronic calendars and, more specifically, systems and methods for granting and receiving electronic calendar access via an exposed application programming interface (API) and systems and methods for collaborating within a shared electronic calendar.

### BACKGROUND OF THE INVENTION

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

An electronic calendar is a software application that enables users to have electronic versions of commonly-used office tools, such as a calendar, appointment book, address book, contact list, and/or task manager. Electronic calendars have become a common and convenient way of keeping track of events, such as appointments, meetings, airplane flights, etc. They permit users to manage their calendar data (e.g., adding contact information, scheduling meetings, or blocking out vacation time) via an easily accessible and manipulatable user interface. Electronic calendars may run on—and be accessed by—virtually any electronic device including a desktop computer, laptop computer, hand held computer, personal digital assistant, and/or cellular or wireless phone. Most electronic calendars are either web-based or client-based.

Web-based electronic calendars operate via software residing on servers that are accessible via a client electronic device connected to the Internet. Examples of web-based electronic calendars include GODADDY.COM ONLINE GROUP CALENDAR, GOOGLE CALENDAR, YAHOO CALENDAR, and MICROSOFT WINDOWS LIVE CALENDAR. Such calendars may be accessed over the Internet by virtually any client. Client-based electronic calendars, on the other hand, operate via software residing on the client and generally may be accessed only via that client. Examples of client-based electronic calendars include MICROSOFT OUTLOOK.

Both web-based and client-based electronic calendars allow users to share access with others. Applicant, however, has noticed that some presently-existing electronic calendars (e.g., MICROSOFT OUTLOOK) only allow second party access after the user accepts an email with an appropriately-formatted attachment. The receipt and acceptance of the attachment accepts the invitation and dockets the event. A rejection precludes docketing of the event and effectively blocks second party access to the calendar. While some electronic calendars permit users to enable direct second-party access, such systems require all shared users to utilize the same electronic calendaring system, or one of a select group of electronic calendaring systems. For example, GOOGLE CALENDAR users may only share electronic calendar access with other GOOGLE CALENDAR users.

Applicant has therefore noticed that presently-existing systems and methods do not allow users to grant a second party direct access to their electronic calendars without the previously-described constrictions. For these reasons, there is a need for the systems and methods for granting and receiving electronic calendar access via an exposed API (and related functionality) as described herein.

Applicant also has noticed that presently-existing electronic calendars limit users' access and/or input to records of a scheduled event to either accepting or denying the event. Current systems, therefore, do not allow calendar users to collaborate with each other regarding a scheduled event within the electronic calendar environment. For these reasons, there is a need for the systems and methods for collaborating within a shared electronic calendar (and related functionality) as described herein.

### SUMMARY OF THE INVENTION

The limitations cited above and others are substantially overcome through the systems and methods disclosed herein, which allow for granting and receiving electronic calendar access via an exposed API and collaborating within a shared electronic calendar.

An exemplary system may include a customer's electronic calendar that is configured to accept an event from a business by exposing the electronic calendar's API to the business. The system may also include a profile manager that allows the customer to add the business to a trust list, which may identify those businesses to which access has been granted. A network may communicatively couple the electronic calendar, customer, business, and profile manager.

An exemplary method for granting electronic calendar access to a second party may comprise the step of adding a business to a trust list. The business may then be granted access to a customer's electronic calendar to schedule an event, perhaps by exposing the electronic calendar's Application Programming Interface (API) to the business. The business may then be notified that it has been granted access. Once an event is scheduled, configured data (compatible with the electronic calendar) may be received from the business, perhaps regarding the event's description, date, time, location, participants, subject matter, priority, relative importance, or any combination thereof. The business may then add, delete, or modify the event in the customer's electronic calendar.

An exemplary method for receiving electronic calendar access from a first party may comprise the step of receiving access to the exposed Application Programming Interface (API) of a customer's electronic calendar to schedule an event. A record indicating access to that customer's electronic calendar may then be stored. Upon the scheduling of the event, a configured data (compatible with said electronic calendar) regarding the event may be generated and transmitted to the customer.

An exemplary system for collaborating within a shared electronic calendar may comprise a web-based electronic calendar having a collaboration tool allowing a plurality of users to collaborate regarding an event scheduled in the electronic calendar. The collaboration tool may comprise a wiki-style software application allowing a plurality of users to discuss, edit, comment, and/or peer-review documents regarding the event.

An exemplary method for collaborating within a shared electronic calendar may comprise the steps of scheduling an event in an electronic calendar, notifying a plurality of users of the event, and collaborating with the users regarding the event via a collaboration tool on the electronic calendar. The collaborating step may be accomplished by accessing a record (accessible to the plurality of users) of the event stored in the electronic calendar, viewing revisions (if any) to the record made by other users, and further revising the record for further review and comment by the other users.

The above features and advantages of the present invention will be better understood from the following detailed description taken in conjunction with the accompanying drawings.

### BRIEF DESCRIPTION OF THE DRAWINGS

FIG. 1 illustrates a possible embodiment of a system for granting and/or receiving electronic calendar access via an exposed API.

FIG. 2 illustrates a possible embodiment of a system for granting and/or receiving electronic calendar access via an exposed API.

FIG. 3 illustrates a possible embodiment of a system for granting and/or receiving electronic calendar access via an exposed API.

FIG. 4 illustrates a possible embodiment of a system for granting and/or receiving electronic calendar access via an exposed API.

FIG. 5 is a flow diagram illustrating a possible embodiment of a method for granting electronic calendar access to a second party via an exposed API.

FIG. 6 is a flow diagram illustrating a possible embodiment of a method for granting electronic calendar access to a second party via an exposed API.

FIG. 7 is a flow diagram illustrating a possible embodiment of a method for receiving electronic calendar access to a second party via an exposed API.

FIG. 8 illustrates a possible embodiment of a system for collaborating within a shared electronic calendar.

FIG. 9 illustrates a possible embodiment of a system for collaborating within a shared electronic calendar.

FIG. 10 illustrates a possible of a system for collaborating within a shared electronic calendar.

FIG. 11 is a flow diagram illustrating a possible embodiment of a method for collaborating within a shared electronic calendar.

FIG. 12 is a flow diagram illustrating a possible embodiment of a method for collaborating within a shared electronic calendar.

FIG. 13 is a flow diagram illustrating a possible embodiment of a method for collaborating within a shared electronic calendar.

FIG. 14 is a flow diagram illustrating a possible embodiment of a method for collaborating within a shared electronic calendar.

FIG. 15 is a flow diagram illustrating a possible embodiment of a method for collaborating within a shared electronic calendar.

FIG. 16 illustrates a screenshot of an example electronic calendar event record in which users have collaborated.

### DETAILED DESCRIPTION

The present inventions will now be discussed in detail with regard to the attached drawing figures which were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

An Electronic Calendaring System Having An Exposed API

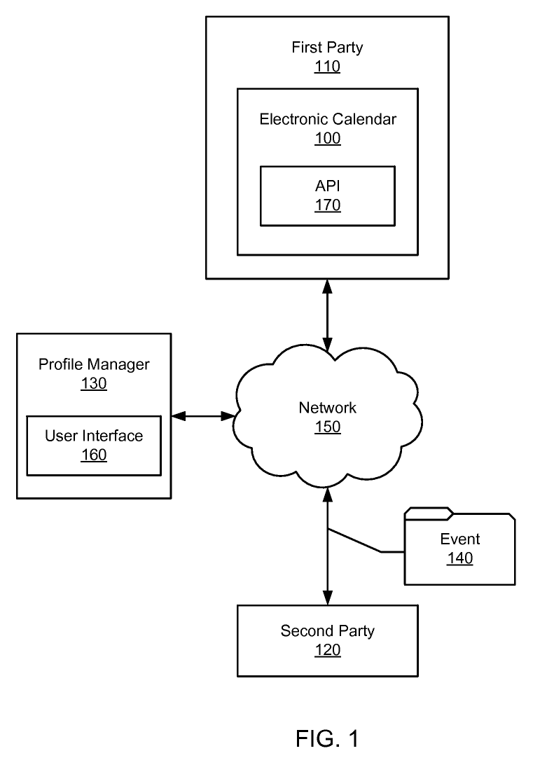

An example embodiment of a system for granting and/or receiving electronic calendar access is illustrated in FIG. 1. The illustrated embodiment includes a first party's 110 electronic calendar 100 configured to accept an event 140 from a second party 120 by exposing the electronic calendar's 100 application programming interface (API) 150 to the second party 120. The system also may include a profile manager 130 allowing the first party 110 to add the second party 120 to a trust list and a network 150 communicatively coupling the electronic calendar 100, first party 110, second party 120, and profile manager 130.

The example embodiments herein place no limitation on network 150 configuration or connectivity. Thus, as non-limiting examples, the network 150 could comprise the Internet, an intranet, an extranet, a local area network, a wide area network, a wired network, a wireless network, a telephone network, or any combination thereof.

System components may be communicatively coupled to the network 150 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The example embodiments herein place no limitations on whom or what may comprise the first party 110 and/or the second party 120. Thus, as non-limiting examples, the first party 110 and/or the second party 120 may comprise any individual, entity, business, corporation, partnership, organization, governmental entity, and/or educational institution that may have occasion to schedule an event in an electronic calendar. The event 140 to be scheduled, as non-limiting examples, may comprise any meeting, appointment, trip, holiday, vacation, delivery, reminder (e.g., birthday or anniversary), and/or any happening scheduled to occur at a particular time and/or place.

The electronic calendar 100 may comprise a software application that enables the first party 110 to, among other things, have electronic access to commonly-used office tools, such as a calendar, appointment book, address book, contact list, and/or task manager. It may have the ability to display the first party's 110 calendar in a plurality of different formats (e.g., hourly, daily, weekly, monthly views, etc.). The electronic calendar 100 could be web-based, client-based, a stand-alone application, a component of a larger application, and/or any combination thereof. In the example embodiment illustrated in FIG. 1, the electronic calendar 100 resides within the first party 110, perhaps on a server or client within the first party's 110 internal network.

The first party's 110 electronic calendar 100 may be configured to accept an event 140 from the second party 120 by having an application programming interface (API) 150 that is exposed to the second party 120. An API is a software-to-software interface that specifies the protocol defining how independent computer programs interact or communicate with each other. The API 170 may allow the second party's 120 software to communicate and interact with the electronic calendar 100—perhaps over the network 150—through a series of function calls (requests for services). It may comprise an interface provided by the electronic calendar 100 to support function calls made of the electronic calendar 100 by other computer programs, perhaps those utilized by the second party 120 to schedule events 140. It also may comprise a collection of pre-configured building blocks allowing the second party to generate a “mashup” (a web application that combines data from more than one source into a single integrated tool) and/or easily configure their software for compatibility and/or extensibility with the electronic calendar 100.

The API 170 may comprise any API type known in the art or developed in the future including, but not limited to, request-style, Berkeley Sockets, Transport Layer Interface (TLI), Representational State Transfer (REST), SOAP, Remote Procedure Calls (RPC), Standard Query Language (SQL), file transfer, message delivery, and/or any combination thereof. The API 170 may be exposed to the second party 120 by any method known in the art or developed in the future including, but not limited to, pointing the second party 120 to a web server to make an HTTP request in the proper function call format. The API's 150 specification may be provided to the second party 120, which may define the function call format required by the API 170. The specified function call format may require identifying information from the second party 120 that may allow the electronic calendar 100 to determine whether the second party 120 attempting to access the API 170 has been granted access by the first party 110. Access to the API 170 then may be governed by an access-protected URL that permits access only to properly-identified entities.

The specified function call format also may call for configured calendar data, perhaps in a standard or modified iCalendar, vCalendar, vCal, or any other specified format that may be compatible with the electronic calendar 100 or the API 170. The configured calendar data may relate to the event's 140 description, topic, objective, date, time, location, participants, subject matter, priority, relative importance, recurrence, resources required for said event 140, and/or any combination thereof. The specified format for the configured calendar data may or may not require additional approval from the first party 110 (e.g., acceptance of an invite) before the event 140 is docketed with the electronic calendar 100. This illustrated configuration may allow the second party 120 to access the first party's 110 electronic calendar 100 to schedule an event 140 irrespective of the calendaring or email system (if any) used by the second party 120.

A profile manager 130 may allow the first party 110 to add the second party 120 to a trust list that may include all entities provided access to the electronic calendar 100. The profile manager 130 may comprise a software-implemented user interface 160, perhaps comprising data fields, dialog boxes, drop-down menus, lists, etc. allowing the first party 110 to select and/or identify entities to which API 170 access may be granted. The profile manager 130 and/or its user interface 160 may be a component of the electronic calendar 100 (irrespective of whether the calendar is web-based or client-based). Alternatively (and as illustrated in FIG. 1), the profile manager 130 and/or user interface 160 may reside on a separate server, client, or a second network communicatively coupled to the electronic calendar 100 (and accessible to the first party 110) via the network 150, perhaps via a webpage on a website.

The profile manager 130 also may allow the first party 110 to revoke the second party's 120 rights to access the API 170. This may be accomplished by removing the second party 120 from the trust list. Where the specified function call requires identifying information from the second party 120, the API 170 may deny access if the second party 120 is absent from the trust list. Alternatively, the profile manager 130 may generate a revoked access list including identifying information for those entities that will expressly be denied access by the API 170.

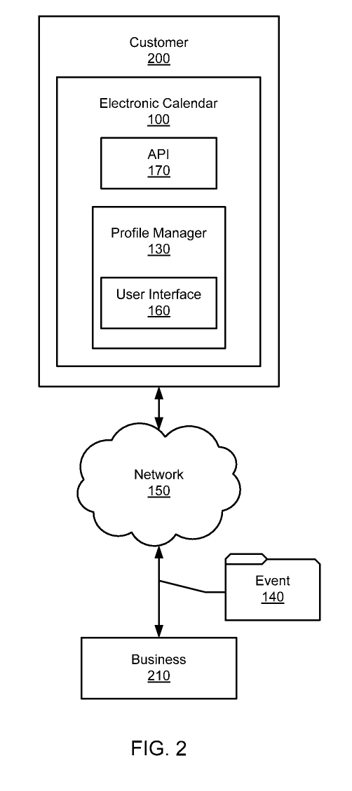

In the embodiment of a system for granting and/or receiving electronic calendar access illustrated in FIG. 2, the profile manager 130 and its user interface 160 are components of the electronic calendar 100, which may reside internal to the customer's 200 systems. In this embodiment, the first party 110 may be a customer 200 of a second party 120, which may be a business 210. The business 210 may comprise any individual or entity selling (or offering for sale) any goods or services. The illustrated system, therefore, allows a customer 200 to grant specified businesses access to the customer's 200 electronic calendar 100 (via an exposed API 170) to schedule events 140 relating to goods or services purchased (or potentially purchased) from said business 210.

By way of example, a customer 200 may grant a business 210, such as domain name registrar GODADDY.COM, access to the customer's 200 electronic calendar 100 by adding GODADDY.COM to a trust list with the user interface 160. When an event 140 needs to be scheduled, perhaps the expiration of a registered domain name, GODADDY.COM may then add the expiration date, or perhaps a renewal reminder, directly into the customer's 200 electronic calendar 100. Similarly, after being granted access, an airline such as ACME AIRLINES may directly insert a flight itinerary, perhaps for a flight purchased online by the customer 200, into the electronic calendar 100. Such calendar insertion may comprise a replacement of, or supplement to, current methods airlines utilize to transmit flight itinerary information (postal mail, email, etc.). If the customer 200 grants calendar access to an online auction business such as EBAY, deadlines for the customer 200 to pay for purchased items (or to ship sold items) may directly docketed with the electronic calendar 100. This system (and the other embodiments described herein) offers virtually unlimited similar applications whenever an event 140 needs to be calendared.

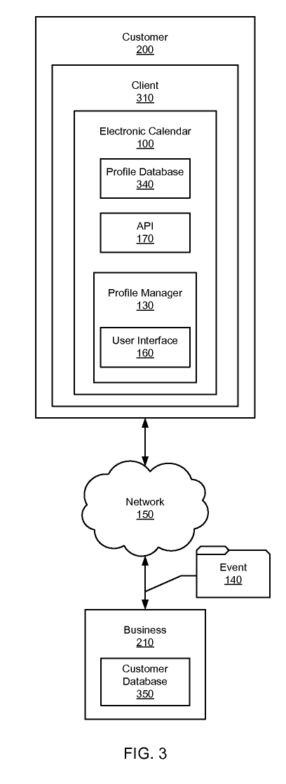

In the embodiment of a system for granting and/or receiving electronic calendar access illustrated in FIG. 3, the electronic calendar 100 is a client-based calendar running on the customer's 200 client 310 and having an API 170 that may be exposed to the business 210. As non-limiting examples, the client 310 may comprise a desktop computer, laptop computer, hand held computer, terminal, television, television set top box, cellular phone, wireless phone, wireless hand held device, Internet access device, rich client, thin client, or any other client functional within a client-server computing architecture. In this example embodiment, the profile manager 130 and its user interface 160 are components of the electronic calendar 100.

In this illustrated embodiment (FIG. 3), the electronic calendar 100 also may comprise a profile database 340 for storing a list of businesses 210 that have been granted access to the electronic calendar 100. In an alternate embodiment, the profile database 340 may reside external to the electronic calendar 100 or the customer 200, perhaps on a server communicatively coupled to the network 150 and accessible by the electronic calendar 100 or the customer 200.

Structurally, the profile database 340 may comprise any collection of data. As non-limiting examples, the profile database 340 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

The profile database 340 may be accessed by the profile manager 130, which may add to or delete from the list of businesses. Data regarding the list of businesses may be transferred to (or deleted from) the profile database 340 by the profile manager 130 utilizing any method of transferring data known in the art or developed in the future. Such methods can generally be classified in two categories: (1) “pull-based” data transfers where the receiver initiates a data transmission request; and (2) “push-based” data transfers where the sender initiates a data transmission request. Both types are expressly included in the embodiments illustrated herein, which also may include transparent data transfers over network file systems, explicit file transfers from dedicated file-transfer services like FTP or HTTP, distributed file transfers over peer-to-peer networks, file transfers over instant messaging systems, file transfers between computers and peripheral devices, and/or file transfers over direct modem or serial (null modem) links, such as XMODEM, YMODEM and ZMODEM. Data streaming technology also may be used to effectuate data transfer. A data stream may be, for example, a sequence of digitally encoded coherent signals (packets of data) used to transmit or receive information that is in transmission. Any data transfer protocol known in the art or developed in the future may be used including, but not limited to: (1) those used with TCP/IP (e.g., FTAM, FTP, HTTP, RCP, SFTP, SCP, or FASTCopy); (2) those used with UDP (e.g., TFTP, FSP, UFTP, or MFTP); (3) those used with direct modem connections; (4) HTTP streaming; (5) Tubular Data Stream Protocol (TDSP); (6) Stream Control Transmission Protocol (SCTP); and/or (7) Real Time Streaming Protocol (RTSP).

This illustrated embodiment (FIG. 3) also may comprise a customer database 350 communicatively coupled to the network 150, which may store a list of customers 200 who have provided the business 210 access to their electronic calendars 100. The customer database 350 allows the business 210 to keep track of those customers 200 to which they have been granted calendar access. The customer database 350 may reside within the business 210, perhaps on a server or client within the businesses' 210 internal network. Alternately, the customer database 350 may reside external to the business 210, perhaps on a server communicatively coupled to the network 150 and accessible by the business 210. Structurally, the customer database 350 may comprise any collection of data, including any of the database types discussed in detail above.

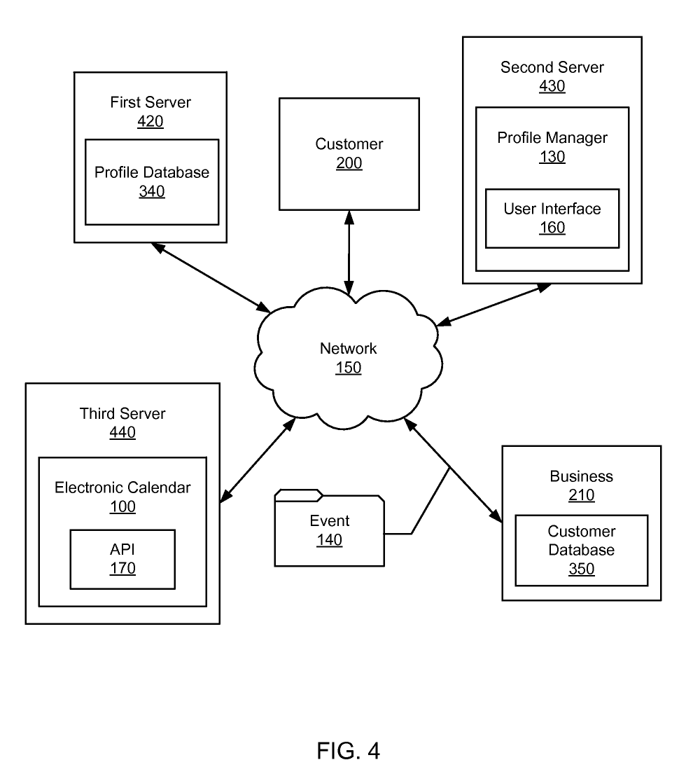

FIG. 4 illustrates a highly-distributed embodiment of a system for granting and/or receiving electronic calendar access. In this embodiment, the profile database 340, profile manager 130, and electronic calendar 100 separately reside on a first server 420, second server, 430, and third server 440 respectively, each of which is communicatively coupled to the network 150. The servers could be any computer or program that provides services to other computers, programs, or users either in the same computer or over a computer network. As non-limiting examples, the servers could be an application, communication, mail, database, proxy, fax, file, media, web, peer-to-peer, or standalone server and may use any server format known in the art or developed in the future (possibly a shared hosting server, a virtual dedicated hosting server, a dedicated hosting server, or any combination thereof). In this example embodiment, system functionality is mostly external to the customer 200 and business 210 and is offered as an example of a web-based, distributed system.

Granting Electronic Calendar Access Via An Exposed API

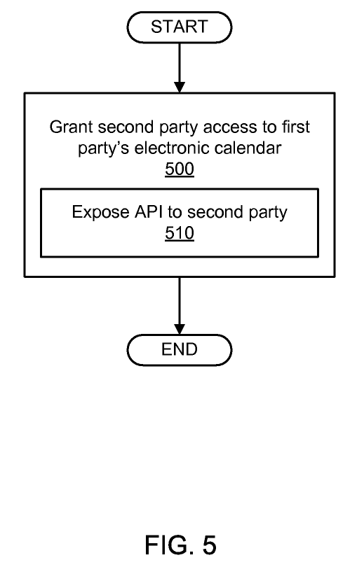

Several different methods may be used for granting electronic calendar access to a second party via an exposed API. In the streamlined example embodiment illustrated in FIG. 5, a second party 120 is granted access to an electronic calendar 100 of a first party 110 to schedule an event 140 (Step 500) by exposing the electronic calendar's 100 API 170 to the second party 120 (Step 510). The API 170 may be exposed to the second party 120 by any method known in the art or developed in the future including, but not limited to, providing the API's 150 specification to the second party 120. The specification may define the function call format required by the API 170. The specified function call format may require identifying information from the second party 120 that may allow the electronic calendar 100 to determine whether the second party 120 attempting to access the API 170 has been granted access by the first party 110. Access to the API 170 then may be governed by an access-protected URL that only permits access to properly-identified entities.

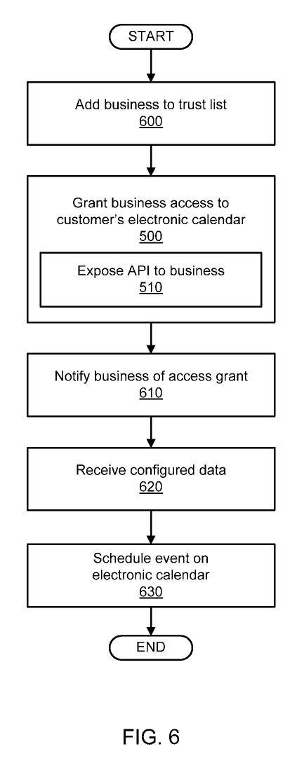

A more detailed method for granting electronic calendar access to a second party via an exposed API is illustrated in FIG. 6. In this illustrated embodiment, the first party 110 may be a customer 200 of a second party 120, which may be a business 210. With this method, a business 210 may be added to a trust list in an electronic calendar 100 (Step 600), perhaps via the profile manager 130 and/or user interface 160 discussed in detail above. This allows the customer 200 to generate a list of those businesses 210 that will have access to his electronic calendar 100. In one possible embodiment, this step could be accomplished by clicking on a “profile manager” icon in the electronic calendar 100. A user interface 160 may then appear, perhaps displaying data fields, dialog boxes, drop-down menus, or lists, etc. allowing the customer 200 to select and/or identify businesses 210 to which access may be granted. The business 210 then may be granted access to a customer's 200 electronic calendar 100 to schedule an event 140 (Step 500) by exposing the electronic calendar's 100 API 170 to the business 210 (Step 510).

The business 210 then may be notified that it has been granted access to electronic calendar's 100 API 170 (Step 610). This notification step may be accomplished by an electronic communication from the electronic calendar 100 to said business 210. As non-limiting examples, the electronic communication may comprise an electronic signal sent to an IP address, an email, an instant message, an HTTP request, and/or any other form of electronic signal from the electronic calendar 100 to the business 210. Electronic contact information (e.g., email address, IP address, etc) for the business 210 may have been provided by the customer 200, perhaps when adding the business 210 to the trust list. Alternatively, the profile manager 130 and/or electronic calendar 100 may store such contact information for businesses 210, perhaps those that have entered a service partnership with the electronic calendar 100 provider. In yet another embodiment, the profile manager 130 and/or electronic calendar 100 may perform an electronic search, perhaps of the Internet, to locate such contact information. Alternatively, the customer 200 may notify the business 210 that it has been granted access. This may be accomplished by, as non-limiting examples, by email, written correspondence, telephone call, or via the businesses 210 website.

Configured data from the business 210 regarding the event 140 then may be received (Step 620), perhaps by the electronic calendar 100 and/or its API 170. The configured data may relate to the event's 140 description, topic, objective, date, time, location, participants, subject matter, priority, relative importance, resources required (e.g., conference room, etc.) or any combination thereof. The data may be in any format compatible with the electronic calendar 100 and/or API 170 including, but not limited to any format required by the API 170, iCalendar format, vCalendar format, vCal format, or any combination thereof iCalendar is a widely-accepted and used calendar data standard (see RFC 2445, which is incorporated herein by reference). It allows users to send meeting requests and tasks to other users, typically through email, but the standard is designed to be independent of the transport protocol. vCalendar was the precursor to, and is generally compatible with, iCalendar. vCal is an open source calendar data standard that can be exported to both the iCalendar or vCalendar formats. Once configured data is received (Step 620), the event 140 may be scheduled on the electronic calendar 100 (Step 630).

Receiving Electronic Calendar Access Via An Exposed API

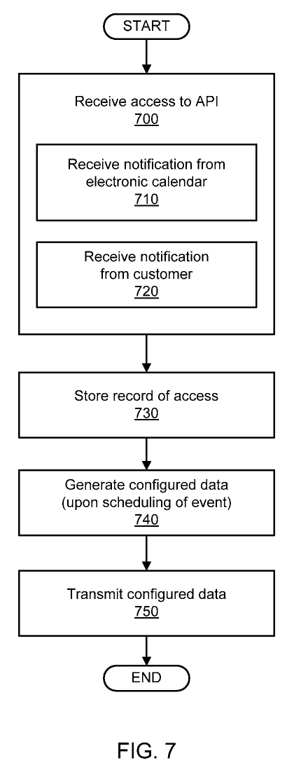

Several different methods may be used for receiving electronic calendar access to a second party via an exposed API. In the streamlined example embodiment illustrated in FIG. 7, access is received to the Application Programming Interface (API) 150 of a first party's 110 electronic calendar's 100 for the purpose of scheduling an event 140 (Step 700). In one possible embodiment, the first party 110 may be a customer 200 of a business 210, perhaps a business 210 that is receiving access to the customer's 200 electronic calendar 100.

Access to the API 170 may be received by any method known in the art or developed in the future including, but not limited to, receiving the API's 150 specification. The specification may define the function call format required by the API 170. The specified function call format may require identifying information that may allow the electronic calendar 100 to determine whether the entity attempting to access the API 170 has been granted access by the first party 110. Access to the API 170 may be controlled by an access-protected webpage.

The step of receiving API 170 access (Step 700) may also comprise the step of receiving an electronic communication from the electronic calendar 100 notifying that access has been granted (Step 710). This step may be accomplished by an electronic communication from the electronic calendar 100. As non-limiting examples, the electronic communication may comprise an electronic signal sent from an IP address, an email, an instant message, an HTTP request, and/or any other form of electronic signal from the electronic calendar 100 to the recipient. Electronic contact information (e.g., email address, IP address, etc) for the recipient may have been provided by the first party 110. Alternatively, the profile manager 130 and/or electronic calendar 100 may store such contact information for potential recipients, perhaps those that have entered a service partnership with the electronic calendar 100 provider. In yet another embodiment, the profile manager 130 and/or electronic calendar 100 may perform an electronic search, perhaps of the Internet, to locate such contact information. Alternatively, the first party 110 may notify the recipient that it has been granted access. This may be accomplished by, as non-limiting examples, by email, written correspondence, telephone call, or via the recipient's website.

A record indicating access to the electronic calendar 100 then may be stored (Step 730), perhaps in a customer database 350. The record may be in any format and include any data structure storing a list of customers 200 who have provided access to their electronic calendars 100. Upon the scheduling of the event 140, configured data regarding the event 140, may be generated (Step 740). The configured data may be in any format compatible with the electronic calendar 100. For example, the API's 150 specified function call format may identify the required configured data format, perhaps in a standard or modified iCalendar, vCalendar, vCal, or any other specified format that may be compatible with the electronic calendar 100 or the API 170. The configured calendar data may relate to the event's 140 description, topic, objective, date, time, location, participants, subject matter, priority, relative importance, resources required for said event 140, or any combination thereof. The specified format for the configured calendar data may or may not require additional approval from the first party 110 (e.g., acceptance of an invite) before the event 140 is docketed with the electronic calendar 100.

The configured data may then be transferred to the first party 110 Step (750), where it may be utilized to add, modify, or delete a calendar item in the electronic calendar 100. The data may be transferred, perhaps via the network 150, by any method of data transfer known in the art or developed in the future including, but not limited to, those methods described elsewhere in this specification.

Systems And Methods For Collaborating Within A Shared Electronic Calendar

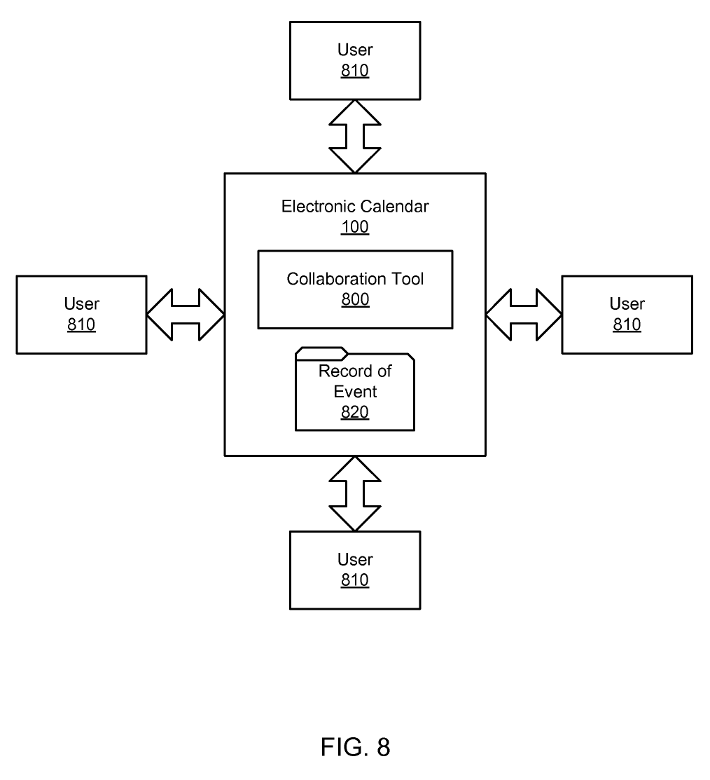

With reference to FIG. 8, users 810 may wish to use an electronic calendar 100 to schedule an event 140 with other users 810, perhaps a meeting to discuss a project. Prior to the meeting, however, users 810 may have comments about the event 140 and/or questions that they would like to ask of (and receive answers from) other users 810. Applicant has noticed, however, that presently-existing electronic calendars do not allow users 810 to collaborate within the electronic calendar environment regarding such a scheduled event 140, or any other subject. For these reasons, there is a need for the systems and methods for collaborating within a shared electronic calendar (and related functionality) as described herein.

The present inventions address this problem by adding the power of a collaboration tool 800 to the electronic calendar 100. In an example embodiment, once calendar users 810 receive an invitation to an event 140, they can accept the invitation and go directly to a record 820 of the event 140 in the electronic calendar 100 and communicate with other invited users 810 and/or perhaps post questions and comments within the record 820 itself. When this occurs, the other invited users 810 will be able to see the posted questions and/or comments, and have option to answer the questions or provide their own comments and/or questions within the record 820.

This illustrated embodiment includes an electronic calendar 100 having a collaboration tool 800 allowing a plurality of users 810 to collaborate regarding an event 140 scheduled with the electronic calendar 100. The example embodiments herein place no limitations on whom or what may comprise users 810. Thus, as non-limiting examples, users 810 may comprise any individual, entity, business, corporation, partnership, organization, governmental entity, and/or educational institution that may have occasion to schedule an event in an electronic calendar 100.

The electronic calendar 100 may comprise a software application that enables users 810 to, among other things, have electronic access to commonly-used office tools, such as a calendar, appointment book, address book, contact list, and/or task manager. It may have the ability to display a user's 810 calendar in a plurality of different formats (e.g., hourly, daily, weekly, monthly views, etc.). The electronic calendar 100 software application also may include calendaring and scheduling tools that may automatically check a user's 810 electronic calendar 100 for available meeting times, suggest available meeting times, schedule user 810 meetings and/or appointments, and/or remind users 810 of scheduled events 140 by email. It could be web-based, client-based, a stand-alone application, a component of a larger application, and/or any combination thereof.

When an event 140 is scheduled, the electronic calendar 100 may generate a record 820 of the scheduled event 140, accessible by all participating users 810 via the electronic calendar 100. As a non-limiting example, a user 810 may invite other users 810 to an event 140 by emailing an invitation with an attachment in a specified format (e.g., a standard or modified iCalendar, vCalendar, vCal, CSV, or any other specified format that may be compatible with the electronic calendar 100). When the user 810 accepts the invitation, the electronic calendar 100 may accept the attached file and generate a record 820 of the event 140 (based on the data in the file) that may be viewed by each user 810. The record 820 of the event 140 may comprise an html page, a website, a webpage, or any file type viewable via a browser and/or client-based electronic calendar 100.

In this illustrated embodiment (FIG. 8), the electronic calendar 100 also may comprise a collaboration tool 800 allowing users 810 to collaborate regarding an event 140 scheduled with the electronic calendar 100. The collaboration tool 800 may comprise a wiki-style software application, an Internet forum software application, an instant messaging software application, an electronic discussion group software application, a weblog software application, an SMS software application, an MMS software application, a text messaging software application, a video messaging software application, a picture messaging software application, or any combination thereof.

Wiki-style software applications are tools that encourage groups of people to participate on collaborative projects. Such applications allow users to collaboratively create, edit, link, and/or organize the content of a website or webpage, which may be known as a “wiki.” A wiki is a collection of text-based pages, interconnected through hyperlinks that may be viewed and edited over the Internet. Wiki-style software applications allow users to collaborate while working on the same project, to share thoughts and discuss matters online at their convenience. WIKIPEDIA is a well-known example of a wiki-style collaborative environment.

As a non-limiting example, a wiki-style collaboration tool 800 may generate a wiki-enabled record 820 viewable and editable by all invited users 810 via the electronic calendar 100. In an example embodiment, the record 820 may comprise a website devoted to the users' 810 collaboration regarding the event 140. Really Simple Syndication (RSS), may be used to notify users 810 when there is a new posting has been made to the record 820 or, alternatively, the collaboration tool 800 could send an email to all invited users 810. Such notification means may be used with any of the collaboration tool 800 software application described herein.

An Internet forum software application also may be used for the collaboration tool 800. Internet forum software may generate a forum, perhaps within the record 820 of the event 140, capable of being written to and read by users 810. The forum may allow users 810 to communicate and interact with each other via any online communication method known in the art or developed in the future including, but not limited to, Internet forums (e.g., Web forums, message boards, discussion boards, (electronic) discussion groups, discussion forums, bulletin boards), IM (instant messaging), VoIP (voice over IP), email, blogs, and/or any combination thereof.

Non-limiting examples of Internet forum software applications that may be used include open-source forum software packages that are widely available on the Internet and are written in a variety of programming languages, such as PHP, Perl, Java, and ASP. The configuration and records of posts can be stored in text files or in a database. Each package offers different features, from the most basic, providing text-only postings, to more advanced packages, offering multimedia support and formatting code. Many packages can be integrated easily into an existing record 820 to allow users 810 to post comments regarding events 140.

Several other Web applications may be used, such as weblog (blog) software (e.g., GODADDY.COM's QUICK BLOGCAST, WORDPRESS, and/or SLASHCODE), which may also incorporate forum features. Full content management systems such as DRUPAL or MAMBO can also incorporate full-blown forums as plugins or basic features of forums in other portions of their website. IM (instant messaging), VoIP (voice over IP), or Wiki functionality also may be built into the collaboration tool 800 to allow users 810 to communicate and collaborate via these formats.

The collaboration tool 800 also may comprise an instant messaging software application that allows one user 810 to communicate with another user 810 over a network in real time. The instant messaging software application may comprise proprietary or third-party (e.g., MICROSOFT OFFICE COMMUNICATOR, JABBER, GTALK, SKYPE, MEEBO, ICQ, YAHOO! MESSENGER, MSN MESSENGER, PIDGIN, and/or AOL INSTANT MESSENGER) systems. The instant messaging software application may comprise client or server-side software. Many instant messaging software applications allow users 810 to generate a contact list by adding other users' 810 email address, messenger ID, or some other digital identification to the list. If a user 810 is online, their name may be displayed indicating that the user 810 may be available for instant messaging. Clicking on a user's 810 name may activate an instant messaging window in which messages may be typed and responses received.

The collaboration tool 800 also may comprise an electronic discussion group software application (i.e., text chat) that allows users 810 to join chat rooms and publicly communicate with many users 810 at the same time. Such applications may comprise proprietary, third-party, client-side, or server-side software. Example chat protocols that may be utilized include, as non-limiting examples, Internet Relay Chat (IRC) and/or eXtensible Messaging and Presence Protocol (XMPP). In many discussion group applications, users 810 may join a pre-existing chat room or create a chat room about any topic. Once in the chat room, users 810 may type messages that other users 810 in the room can read and respond to. There may be a steady stream of users 810 entering and leaving. When a user 810 is in a chat room, they may invite other users 810 to join and participate in the chat.

The collaboration tool 800 also may comprise text messaging, picture messaging, or video messaging applications. Text messaging comprises sending and/or receiving short message files, usually from mobile phones or other personal digital assistants using the Short Message Service (SMS) protocol. Picture and video messaging may comprise sending and/or receiving multimedia objects (images, audio, video, rich text, etc.) between similar devices, perhaps using the Multimedia Messaging Service (MMS) protocol. SMS and MMS messages often consist of communication between mobile phones or other personal digital assistants. Collaboration tool 800 applications using these protocols may be configured to receive and respond to SMS and/or MMS messages. Such applications may generate (or receive) files including, but not limited to, SMS, MMS, text, audio, image, or video files (or any combination thereof) that may be stored and organized, perhaps in a file manager.

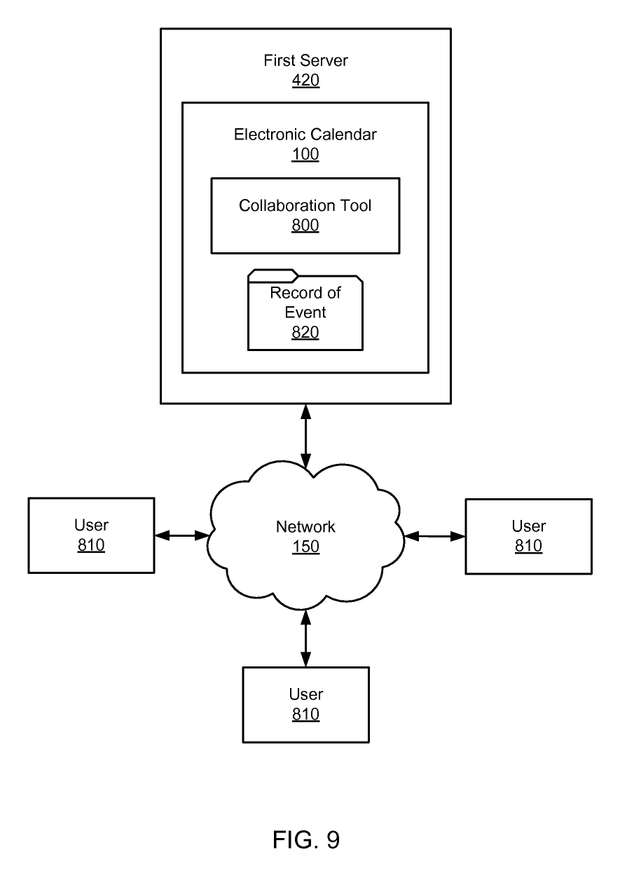

The example embodiment in FIG. 9 illustrates a web-based system for collaborating within a shared electronic calendar. In this embodiment, the electronic calendar 100 software may reside on a first server 420, which is communicatively coupled to the network 150. Users 810 may access the electronic calendar 100 via the network 150.

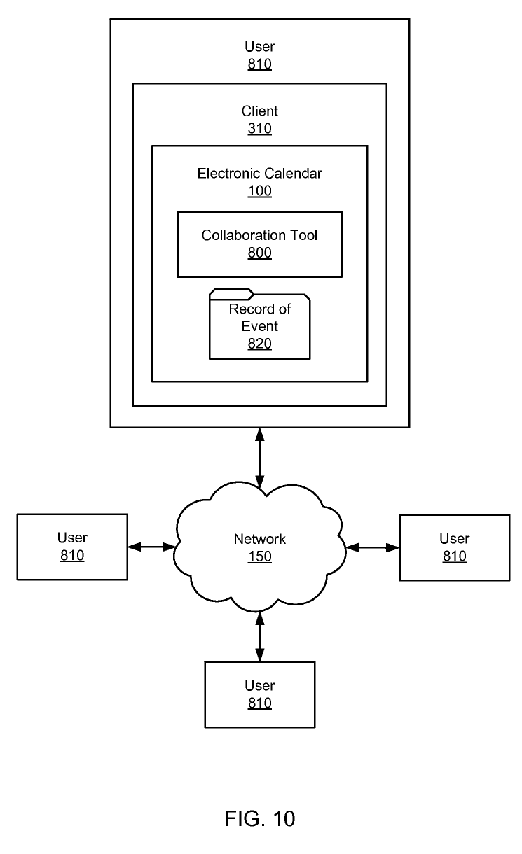

The example embodiment in FIG. 10 illustrates a client-based system for granting collaborating within a shared electronic calendar. In this embodiment, the electronic calendar 100 resides within a user's 810 systems, perhaps on a client 310 within the user's 810 internal network.

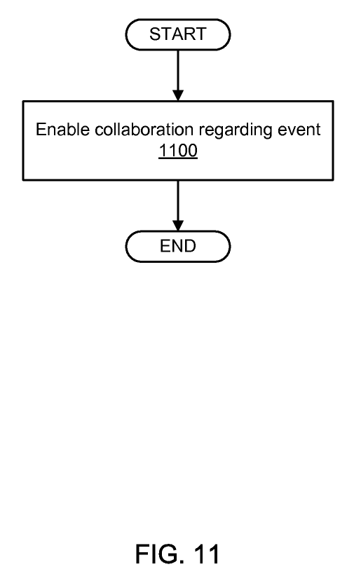

Several different methods may be used for collaborating within a shared electronic calendar. In the example embodiment illustrated in FIG. 11 a plurality of users 810 may be enabled to collaborate regarding an event 140 via a collaboration tool 800 on an electronic calendar 100 (Step 1100). This may be accomplished by providing users 810 with any level of access to any of the above-described electronic calendars 100. As non-limiting examples, access may be provided by providing web-based and/or client-based electronic calendar services implementing the above-described features.

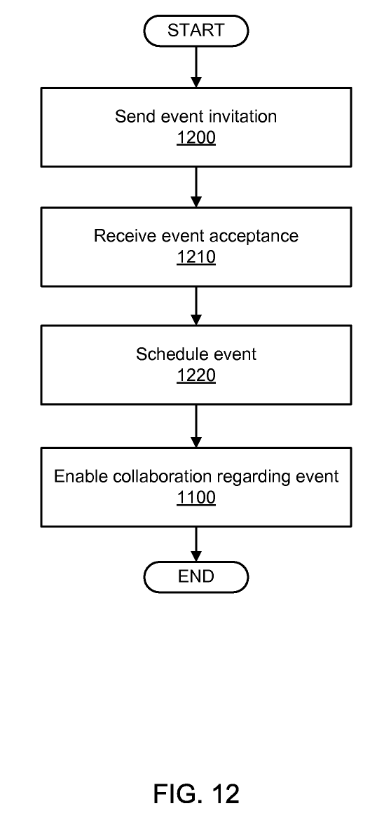

A more detailed method for collaborating within a shared electronic calendar is illustrated in FIG. 12. In this example, an invitation to an event 140 may be sent to a plurality of users 810 via an electronic calendar 100 (Step 1200). As a non-limiting example, a user 810 may invite other users 810 to an event 140 by emailing an invitation with an attachment in a specified format (e.g., a standard or modified iCalendar, vCalendar, vCal, CSV, or any other specified format that may be compatible with the electronic calendar 100). Alternatively, the invitation may comprise any electronic communication including, but not limited to, those discussed in detail above (i.e., IM, text, chat messages, etc.). The invitation may be sent using any method of transferring data known in the art or developed in the future including, but not limited to, those discussed in detail elsewhere in this application. An acceptance of the event 140 may then be received from at least one of the users 810 (Step 1210). The acceptance may be in the form of a reply email, and/or any other electronic communication including, but not limited to, those discussed in detail above. Upon receipt of the acceptance, the event 140 may be scheduled in the electronic calendar 100 (Step 1220).

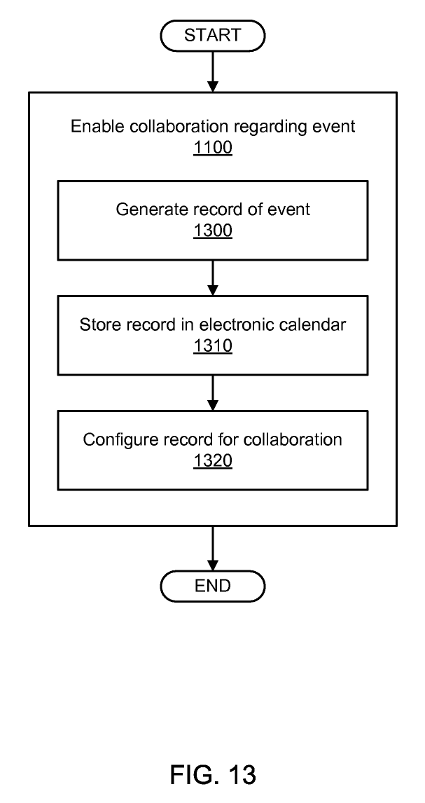

The users 810 may be enabled to collaborate regarding the event 140 via a collaboration tool 800 on the electronic calendar 100 (Step 1100) as described in detail above. As illustrated in FIG. 13, this enabling step (Step 1100) may be accomplished by generating (Step 1300), storing (Step 1310), and configuring for collaboration (Step 1320) a record 820 of the event 140. Thus, after the user 810 accepts the invitation, the electronic calendar 100 may generate a record 820 of the event 140 (perhaps based upon data in the invitation) that may be viewed by each user 810 (Step 1300). The record 820 of the event 140 may comprise an html page, a website, a webpage, or any file type viewable via a browser and/or client-based electronic calendar 100. The record 820 (that may be accessible users 810 via the electronic calendar 100) then may be stored in memory accessible by the electronic calendar 100 (Step 1310).

The record 810 may be configured for user 810 collaboration (Step 1310) by any means known in the art or developed in the future allowing users 810 to communicate and/or interact regarding the event 120 (or any other subject) including, but not limited to, enabling wiki-style, Internet forum, instant messaging, electronic discussion group, weblog, SMS, MMS, text messaging, video messaging, picture messaging (or any combination thereof) functionality in the record 820. Such functionality may be implemented in the record 820 by configuring the electronic calendar 100 with the related software applications discussed in detail above.

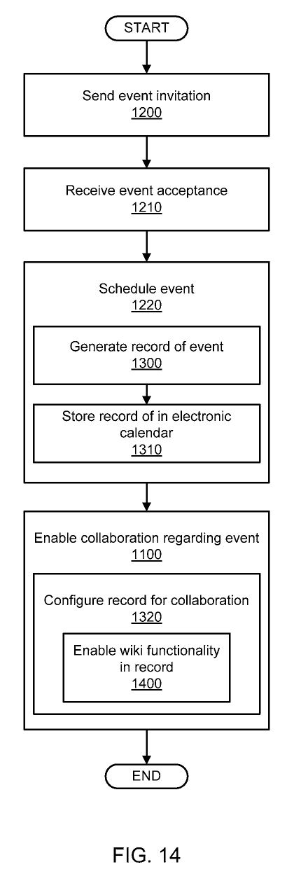

FIG. 14 illustrates a detailed embodiment of a method for collaborating within a shared electronic calendar, wherein the record 820 generating (Step 1300) and storing (Step 1310) steps may be accomplished during the scheduling an event 140 step (Step 1220). In this example embodiment, collaboration may be enabled (Step 1100) by configuring the record 820 for collaboration (Step 1320) with wiki-style functionality (Step 1400).

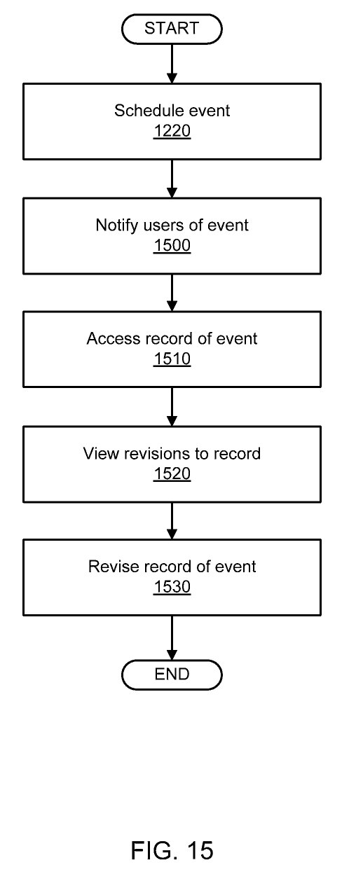

FIG. 15 illustrates another embodiment of a method for collaborating within a shared electronic calendar. In this example embodiment, an event 140 may be scheduled in an electronic calendar 100 (Step 1220) and a plurality of users 810 may be notified of the event 140 (Step 1500). Any method of notification (Step 1500) known in the art or developed in the future may be used including, but not limited to those discussed in detail elsewhere in this application. As a non-limiting example, users 810 may be notified of a scheduled event 140 by emailing a notification and/or an invitation with an attachment in a specified format (e.g., a standard or modified iCalendar, vCalendar, vCal, CSV, or any other specified format that may be compatible with the electronic calendar 100). Alternatively, the notification may comprise any electronic communication including, but not limited to, those discussed in detail above (i.e., IM, text, chat messages, etc.). The notification may be sent using any method of transferring data known in the art or developed in the future including, but not limited to, those discussed in detail elsewhere in this application.

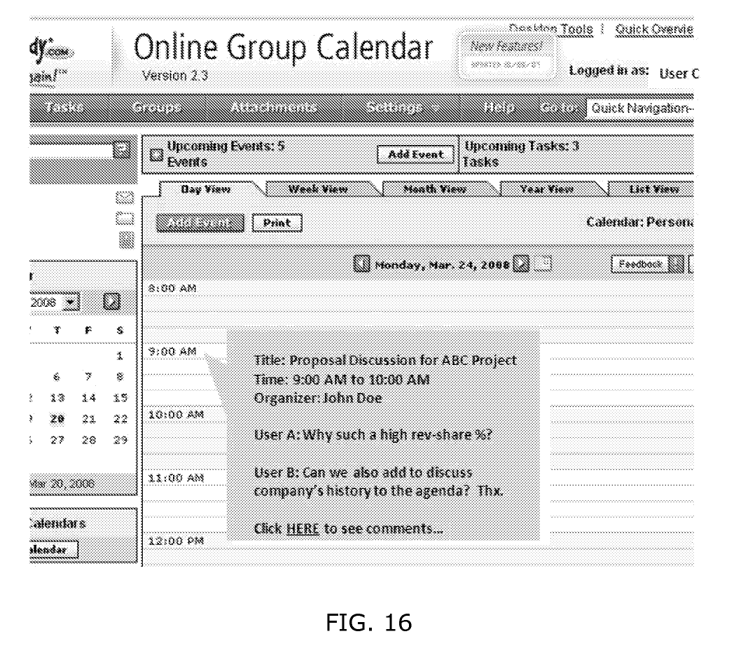

Other users 810 then may be collaborated with regarding the event 140 via a collaboration tool 800 in the electronic calendar 100. In this example embodiment, this collaborating step may be accomplished by accessing a record 820 of the event (140) via the electronic calendar 100 (Step 1510), viewing revisions to the record 820 made by other users (810) (Step 1520), and revising the record 820 (Step 1530). The record, in all incarnations and states of update, may be accessible to all users 810 via the electronic calendar 100. FIG. 16 shows an example record 820 of an event 140 as may be viewed in a user's 810 electronic calendar 100. In this example, three users 810 (User A, User B, and User C) collaborate with each other via an IM software application.

Example Uses Of The Systems And Methods Described Herein

In another example embodiment, a customer 200 may wish to purchase an airplane ticket for an upcoming vacation, perhaps from ACME AIRLINES. The customer 200, who may use a web-based electronic calendar 100, such as GODADDY.COM ONLINE GROUP CALENDAR, may access the electronic calendar 100 on his client 310, which may be a desktop computer. If he has not already done so, the customer 200 may add ACME AIRLINES to a trust list (Step 600) via a profile manager 130 on his electronic calendar 100, perhaps by selecting ACME AIRLINES from the list of airlines listed in the user interface 160. A profile database 340, which may be a component of the electronic calendar 100, may then be updated to include ACME AIRLINES on the trust list.

ACME AIRLINES then may be granted access to the API 170 of the customer's 200 electronic calendar 100 (Steps 500-510), possibly by providing ACME AIRLINES with the API's 150 function call specification, requiring ACME AIRLINES to include properly-formatted identifying information in any function call, and granting access (perhaps via an access-protected URL) only when such information is included. The electronic calendar 100 then may electronically notify ACME AIRLINES that is has been granted access to the customer's 200 electronic calendar's 100 API 170 (610), perhaps by sending an automated email notification. Once ACME AIRLINES receives the electronic notification (Step 710), it may store a record, perhaps in a customer database 350, indicating that it now has access to this specific customer's electronic calendar 100 (Step 730) should the need arise to schedule an event 140.

The customer 200 then may, via his client 310, access ACME AIRLINE'S website to purchase his ticket. After selecting the appropriate itinerary and purchasing his ticket, the customer 200 may request, perhaps via a drop-down menu on the website, to have his itinerary delivered via electronic calendar 100 insertion, rather than via email or paper delivery. Alternatively, ACME AIRLINES, having already been granted electronic calendar 100 access, may utilize this delivery method by default, or in conjunction with other delivery methods.

ACME AIRLINES may then generate configured data (Step 740) regarding the customer's 200 flight information (e.g., departure date, time, and destination city) that is compatible with the electronic calendar 100, perhaps by following the API's 150 specification. The configured data is then transmitted to the customer 200 (Step 750), perhaps via file transfer protocol over the Internet. Once the configured data is received (Step 620), the customer's 200 flight date, time, and destination city into his electronic calendar 100 as an event 140 (Step 630).

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the step of: enabling a plurality of users to collaborate regarding an event scheduled in an electronic calendar via a collaboration tool on said electronic calendar.

2. The method of claim 1, further comprising the steps of:
a) sending, via said electronic calendar, an invitation to said plurality of users to accept said event;
b) receiving an acceptance of said event from at least one of said plurality of users; and
c) upon receipt of said acceptance, scheduling said event on said electronic calendar.

3. The method of claim 1, wherein said enabling step further comprises the steps of:
i) generating a record of said event;
ii) storing said record in said electronic calendar, said record being accessible to said plurality of users via said electronic calendar; and
iii) configuring said record for collaboration by said plurality of users.

4. The method of claim 3, wherein said configuring step is accomplished by enabling wiki-style functionality in said record.

5. The method of claim 3, wherein said configuring step is accomplished by enabling Internet forum functionality in said record.

6. The method of claim 3, wherein said configuring step is accomplished by enabling instant messaging functionality in said record.

7. The method of claim 3, wherein said configuring step is accomplished by enabling electronic discussion group functionality in said record.

8. The method of claim 3, wherein said configuring step is accomplished by enabling weblog functionality in said record.

9. The method of claim 3, wherein said configuring step is accomplished by enabling text messaging functionality in said record.

10. The method of claim 3, wherein said configuring step is accomplished by enabling video messaging functionality in said record.

11. The method of claim 3, wherein said configuring step is accomplished by enabling picture messaging functionality in said record.

12. A method, comprising the steps of:
a) sending, via an electronic calendar, an invitation to a plurality of users to accept an event;
b) receiving an acceptance of said event from at least one of said plurality of users;
c) upon receipt of said acceptance, scheduling said event on said electronic calendar by: i) generating a record of said event; and ii) storing said record in said electronic calendar, said record being accessible to said plurality of users via said electronic calendar; and
d) enabling said plurality of users to collaborate regarding said event via a collaboration tool on said electronic calendar by enabling wiki-style functionality in said record.

13. A method, comprising the steps of:
a) scheduling an event in an electronic calendar;
b) notifying a plurality of users of said event; and
c) collaborating with said plurality of users regarding said event via a collaboration tool on said electronic calendar.

14. The method of claim 13, wherein said collaborating step c) is accomplished via a wiki-style software application.

15. The method of claim 13, wherein said collaborating step c) is accomplished via an Internet forum software application.

16. The method of claim 13, wherein said collaborating step c) is accomplished via an instant messaging software application.

17. The method of claim 13, wherein said collaborating step c) is accomplished via an electronic discussion group software application.

18. The method of claim 13, wherein said collaborating step c) is accomplished via a weblog software application.

19. The method of claim 13, wherein said collaborating step c) is accomplished via a text messaging software application.

20. The method of claim 13, wherein said collaborating step c) is accomplished via a video messaging software application.

21. The method of claim 13, wherein said collaborating step c) is accomplished via a picture messaging software application.

22. The method of claim 13, wherein said collaborating step is accomplished by:
i) accessing a record of said event in said electronic calendar, said record being accessible to said plurality of users;
ii) viewing revisions to said record made by said plurality of users; and
iii) revising said record of said event.
